(19) United States
(12) Patent Application Publication
(10) Pub. No.: US 2010/0216639 A1
(43) Pub. Date: Aug. 26, 2010

(54) GYPSUM SOIL CONDITIONER

(76) Inventor: Jonathon W. Hubbs, Phoenix, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/390,396

(22) Filed: Feb. 20, 2009

(51) Int. Cl. A01N 59/02; A01P 21/00

(52) U.S. Cl. 504/188

(57) ABSTRACT

Soil conditioning products according to the invention preferably include gypsum and organic binder. One or more of an oil, a polymeric binder, a gel, fibers and wax could also be included. The invention further includes surface materials comprising a soil and a soil conditioning product according to the invention. Other materials may be added to any of these soil conditioning products or surface materials.

### FIELD OF THE INVENTION

The invention relates to products that can be used to condition soil, surface materials comprising the products and soil, and processes for making same. Soil conditioning products according to the invention, include (1) gypsum, and (2) an organic binder. They may optionally include one or more other materials, such as an oil, a polymeric binder, a gel, fibers, and a wax. Surface materials according to the invention include soil combined with a soil conditioning product according to the invention.

### BACKGROUND OF THE INVENTION

As used herein and throughout, the terms in quotations below are defined as follows:
a. The term “soil” refers to any mixture of particulate surface material of the earth, whether or not it contains organic matter, and includes sand silt, clay and crushed rock such as decomposed granite, or any combination thereof.
b. The term “sand” refers to any granular material formed by the disintegration of rocks to form particles smaller than gravel but coarser than silt. Sand may or may not include organic matter.
c. The term “silt” refers to any unconsolidated sedimentary material with rock particles usually 1/20 millimeter or less in diameter, and being generally smaller than sand but coarser than clay. Silt may or may not include organic matter.
d. The term “clay” refers to any (1) inorganic earth surface material that is plastic when moist but hard when fired and that is comprised primarily of hydrous aluminum silicates and/or other minerals, or (2) substance having the properties of clay. Clay includes dry or wet materials and may or may not include organic matter.
e. The term “organic binder” refers to any carrier that consists primarily of organic matter and that tends to bind soil particles together when mixed with soil, wetted and subsequently dried. Organic binders include dried and ground plantago.
f. The term “carrier” refers to any material that is granular (or particulate) at room temperature and that, when mixed with one or more of a particular oil, soil conditioning product, polymeric binder, gel and/or wax forms a soil conditioning product that may be mixed with soil as a granular material rather than as a liquid. The carrier is preferably an organic binder such as dried and ground plantago.
g. The term “fibers” refers to any fibers, ribbons, or strips of material used to add mechanical strength to soil.
h. The term “oil” means any substance, such as soy bean oil, cotton seed oil, petroleum oil, paraffinic oil, naphthenic oil, IGI HT-100 oil, or mineral oil, into which a polymeric binder can be dispersed or dissolved and that when mixed with an organic binder, and/or a soil conditioning product and a polymeric binder yields a soil conditioning product. In the context of this invention, “oil” could be an aqueous solution, depending upon the nature of the organic binder, the soil conditioning product, and the polymeric binder.
i. The term “polymeric binder” or “polymeric soil binder” means a soil binder that binds together soil particles and that can be dispersed or dissolved into the oil.
j. The term “soil conditioning product” or “soil conditioner” means any mixture of one or more of an organic binder, gypsum, vermiculite, perlite, an oil, a polymeric binder, a gel and a wax. Other materials may be included as well.
k. The term “surface material” means any mixture of soil and a soil conditioning product according to the invention.

It is known to mix organic binder with soil to create an improved surface material and such a process and product are disclosed in U.S. Pat. No. Re. 35,989 to Hubbs et al. U.S. Pat. No. 5,559,166, U.S. Pat. No. 4,792,133 to Hawkins et. al., U.S. Pat. No. 4,852,870 to Hawkins et al., U.S. Pat. No. 4,968,024 to Hawkins and EP 0 419 170 A3, published Mar. 27, 1991, also disclose various soil additives and surfaces formed using the additives.

The disclosures of: U.S. Pat. Nos. 5,746,546 and 6,821,332 to Hubbs and application Ser. Nos. 11/007,658 and 11/452,107 are incorporated herein by reference to the extent they are not inconsistent with this application. The disclosure of U.S. Pat. No. 5,559,166, to the extent it discloses oils and polymeric binders that may be used in the inventions claimed herein, is also incorporated herein by reference.

### SUMMARY OF THE INVENTION

The present invention relates to soil conditioning products, processes for making same, surface materials including soil and a soil conditioning product, and processes for making same. A soil conditioning product according to the invention preferably includes (1) gypsum, and (2) an organic binder, such as dried and ground plantago seed husk. The resulting product, when mixed with soil to form a surface material, placed on a surface, wetted and allowed to dry, allows for improved water drainage. Other materials, such as wax, oil, fibers, gel or polymeric binder could also be included.

Surface materials according to the invention include a soil combined with a soil conditioning product according to the invention.

A preferred process for making a surface material comprises mixing a soil conditioner according to the invention with soil. This typically includes mixing gypsum and organic binder with soil, which may be done at the same time or done one at a time. Further, the gypsum and organic binder may be pre-mixed and then mixed with the soil.

Other materials, such as one or more of an oil, a polymeric binder, a gel, fibers or wax, may also be added to the soil conditioner or the surface material at any suitable time and in any suitable fashion, such as by pug mill blending or bucket blending, or in situ by raking or hoeing the soil conditioner into a pre-existing surface or into soil that has previously been placed onto a pre-existing existing surface.

Another process for making a soil conditioner comprises adding oil, polymeric binder, such as dried and ground plantago seed husk, so that the resulting soil conditioner is granular at least at temperatures between 60° F. and 90° F. This mixture could then be mixed with gypsum and added to soil or the mixture and gypsum may be mixed separately to the soil.

Certain materials (such as wax) may also be emulsified and added to the organic binder and/or soil conditioning product as one or more emulsifications. Some various constituents and methods of combining them are described in co-pending application Ser. Nos. 11/007,658 and 11/452,107.

A soil conditioner can be mixed with soil using any suitable technique, such as a concrete mixer, pug mill, by raking or hoeing in situ, or by bucket blending (which is usually done by using the bucket of a front-end loader).

Both the foregoing general description and the following detailed description are exemplary and explanatory only and not restrictive of the invention as claimed.

### DETAILED DESCRIPTION OF PREFERRED EMBODIMENTS OF THE INVENTION

The present invention relates to (a) a soil conditioning product, and (b) a surface material including a soil conditioner, wherein the soil conditioner includes (1) gypsum, and (2) an organic binder. The soil conditioner or the surface material could also include one or more other materials, such as a polymeric binder, oil, a gel, fibers, and wax.

Each of the components is described below.

### Soil Conditioning Product

The amount and type of soil conditioning product included is selected to provide the desired properties of the resulting surface material. In the preferred embodiment, the soil conditioning product comprises gypsum and an organic binder (preferably dried and ground plantago seed husk). Preferably, the soil conditioning product includes a substantially equal parts mixture of gypsum and organic binder by weight. Alternatively, the soil conditioning product comprises between 20% and 80% by weight of gypsum, although other weight percentages may be utilized depending upon the nature of the type(s) of organic binder used, and whether oil, polymeric binder, gel, fibers and/or wax are added, the type of soil to which the soil conditioner is to be added, and the desired properties of the surface material.

Any form of gypsum (e.g., liquid gypsum and/or powdered gypsum) can be utilized in the present invention, and impurities or other materials (such as organic matter) may be present in the gypsum. The gypsum also assists in allowing water to reach the organic binder and activating the organic binder more quickly.

Additionally, a soil conditioning product according to the present invention may include liquid gypsum, which is added to soil with organic binder in any manner set forth herein and in the same preferred weight percentages, although any suitable weight percentage may be used. In one embodiment of the present invention, a soil conditioning product includes a mixture of about 1 fluid cup of liquid gypsum per 100 gallons of wax, which is then added to the soil with organic binder or separately from the organic binder. In this embodiment, the soil conditioner includes between about 5 gallons and about 50 gallons of the liquid gypsum/wax mixture per ton of soil, with a ratio of about 15 gallons per ton of soil being most preferred. The liquid gypsum/wax mixture may be mixed (along with any other materials) into the soil conditioning product in any suitable manner.

The soil conditioning product may instead include (a) one or more of gypsum, vermiculite and perlite, and (b) an organic binder. These materials may be mixed in any suitable weight percentage and may be mixed with other materials.

### Organic Binder

A soil conditioning product or surface material according to the invention may include an organic binder (as used herein “an” organic binder means one or more organic binders). The organic binder is preferably dried and ground plantago. If dried and ground plantago is used, it preferably includes plantago seed husk and preferably includes 80% or more plantago seed husk, and most preferably includes 90% or more plantago seed husk. Other binders, either organic (such as powdered guar gum) or inorganic, may be utilized alone or in combination.

The amount and type of organic binder included is chosen to provide the desired properties of the soil conditioning product. Preferably, a soil conditioning product includes substantially equal parts mixture of gypsum and organic binder by weight. Alternatively, a soil conditioning product may comprise between about 20% and about 80% by weight of gypsum, although other weight percentages may be utilized depending upon the nature of the organic binder and the type(s) of soil conditioning product, oil, polymeric binder, gel and/or wax added (if any), the type of soil to which the soil conditioner is to be added, and the desired properties of the conditioned soil.

### Oil

The term “oil” means any substance, such as a non or low aromatic oil, paraffinic oil, soy bean oil, cotton seed oil, other vegetable oil, petroleum oil, or mineral oil, into which a polymeric binder can be dispersed or dissolved. “Oil” could also be an aqueous solution, depending upon the nature of the organic binder (if utilized) and other constituents (if utilized), although a non-aqueous solution is preferred. As used herein, “an” oil refers to one or more oils. An oil may alone, or in combination with one or more other constituents, be added to soil, an organic binder and/or soil conditioning product, in any suitable form, such as a liquid (with or without heating) or as one or more emulsions. In one aspect of the present invention, the purpose of the oil is to provide a medium in which to dissolve or disperse the polymeric binder, gel, and/or wax and create a formulation that may be mixed with the organic binder and/or soil conditioning product to form a substance that can be added to soil as a granular material.

Among the suitable petroleum oils are those containing low or no aromatic fractions, and that are generally fluid at temperatures between about 30° F. and about 120° F. Examples of oils suitable for use in the present invention include paraffinic oils and low-aromatic naphthenic oils. A commercially available example of a paraffinic oil includes Exxon's 150 SE solvent extracted bright stock FN-2507, and of a low-aromatic naphthenic oil includes Cyclolube No. 2290 available from Witco. Additionally, soy oil, cotton seed oil, other vegetable oils, or mineral oil may be used. The most preferred oil is soy oil. An example of a commercially available soy oil is Archer Soybean Oil, product no. 86-070-0 available from Archer Daniels Midland Company, Oils and Fats Division, 4666 Faries Parkway, Ill. HT-100 mineral oil from IGI is most preferred among mineral oils.

### Polymeric Binder

A polymeric binder according to the invention is any substance that may be dissolved or dispersed in an oil, that is tackier than and has a higher viscosity than the oil, and that provides adhesion between soil particles. As used herein, “a” polymeric binder means one or more polymeric binders. The polymeric binder helps to seal the outer surface of the surface material, because of the particle adhesion it provides, and because it preferably is water resistant. A polymeric binder may alone, or in combination with one or more other constituents, be added to a soil or an organic binder and/or a soil conditioning product in any suitable form, such as a liquid (with or without heating, depending on the properties of the polymeric binder) or as one or more emulsions.

Polymeric binders suitable for use in the present invention include interpolymers of butene, ethylene, and/or propylene with ethylenically unsaturated monomers, including vinyl acetate, methyl acrylate, and ethyl acrylate. Other polymeric binders suitable for use in the present invention include amorphous polymers that are soluble or dispersible in an oil according to the invention. Commercially available examples of suitable polymeric binders include VESTOPLAST 608 or 708. The most preferred polymeric binder is VESTOPLAST S1, and is supplied by CREANOVA Inc., Turner Place, Box 365, Piscataway, N.J. 08855.

### Gel

The term “gel” means a gelatinous material, such as petroleum jelly. A gel according to the invention can be used in place of oil, or in addition to the oil, or in place of the polymeric binder, or in place of oil and polymeric binder, or alone, or just as another constituent along with other constituents: a gel may be selected for use in conjunction with the present invention according to any desired criteria, such as depending upon the viscosity of the gel, its ability to bind soil particles, the type of soil utilized, the other constituents utilized, and the desired properties of the surface material. As used herein “a” gel means one or more gels. A gel may alone, or in combination with one or more other constituents, be added to a soil and/or an organic binder or a soil conditioning product in any suitable form, such as a liquid (with or without heating, depending on the properties of the gel) or as one or more emulsions.

A preferred gel is PETOX 310, which has the consistency of soft petroleum jelly.

### Wax

A soil conditioning product and surface material of the present invention may include a wax. The term “wax” means any substance, such as soy wax, other vegetable waxes, microcrystalline-based slack wax, or paraffin wax, that has water repellency properties and softens when heated to between about 80° F. and about 400° F., and most preferably between about 80° F. and about 200° F., so that it can be mixed with (1) a soil and one or more of soil conditioning product and an organic binder, or (2) one or more of an oil, gel and/or polymeric binder to be further mixed with soil and/or an organic binder and/or soil conditioning product. As used herein “a” wax means one or more waxes and a wax used in the invention may or may not be microcrystalline. A wax may alone, or in combination with one or more other constituents, be added to a soil or an organic binder and/or a soil conditioning product in any suitable form, such as a liquid (with or without heating, depending on the properties of the wax) or as one or more emulsions, powders or pelletized waxes.

The most preferred wax is a soy wax. Among the soy waxes that may be used to practice the present invention are hydrogenated soybean oil product numbers 86-193-0 and 88-583-0 sold by Archer, Daniels Midland Company, Oils and Fats Division, 4666 Faries Parkway, Decatur, Ill. In alternate embodiments, the soy wax may be a partially hydrogenated soybean oil.

### Soil

The term “soil” refers to particulate surface material of the earth, whether or not it contains organic matter, and includes one or more of sand, silt, clay, and crushed rock, such as decomposed granite. Soil may include other components, such as pebbles or stones, as well.

A preferred clay comes dried in packages and is called “Mud Gel Wyoming Bentonite” sold by Baroid Drilling Fluids, P.O. Box 1675, Houston, Tex. 77251. However, it is believed that any clay could be used to practice the invention and the clay could either be dry or moist. Clay is typically used to provide particles that are cohesive when wetted to form a malleable, and sufficiently firm, surface material. A clay surface can be extremely firm when dry.

Virtually any decomposed granite (also referred to as “D.G.”) having sand particles may be used, including ¼″ D.G. or D.G. finely screened to 2 mil size.

### Making the Surface Material

It is preferred that between about 5-200 pounds, and most preferably about 8-20, 10-100, or about 15-50 pounds, of a soil conditioning product according to the invention be added to one ton of soil, depending upon the consistency and type of the soil and soil conditioner and the desired characteristics of the surface material.

A soil conditioning product according to the invention may be blended or mixed with soil in any suitable manner. If the organic binder comprises plantago or has properties similar to plantago, the surface material could be watered, preferably compressed, and then allowed to dry. The oil, gel, polymeric binder, and/or wax (if used) help provide water resistance and perhaps some soil adhesion, depending upon the adhesive properties of the material(s) used.

The surface material may be applied to a surface in any manner and spread to any desired depth, such methods of applying and spreading surface material being known to those skilled in the art. Generally, the surface material would be placed upon the surface at a desired depth and compacted or compressed, using any suitable method, prior to use. The surface material may be watered prior to being compacted or compressed. It may also be graded, raked, and/or dried prior to use. A typical depth for the surface material is between 2″ and 8″, although any suitable depth may be utilized.

After watering, the wet surface material is preferably allowed to at least partially dry. Normally, under dry conditions, the surface material is allowed to dry for a day or so. The surface material may then be compacted using any suitable method, such as a pneumatic or heavy-weighted steel faced roller.

A soil conditioner may also be added to existing soil in situ. In that case, the area to be treated may be loosened by rototilling or raking, hoeing, or otherwise tilled by hand to loosen the soil. The soil conditioner, as described above, is spread over the surface of the area to be treated. Typically, the soil conditioner is mixed to a depth of about 2 to 8 inches. The depth of application will vary with the nature of the soil and the application. Preferably, the conditioner is worked until it is substantially uniformly dispersed through the soil. The mixture of existing soil and soil conditioner is then preferably watered, compacted, dried and/or raked, as previously described and as known to those skilled in the art.

Embodiments of the invention (either soil conditioner or surface material) may also be used to adhere stones (including flat stones such as flag stone), bricks, pebbles, or other material on a path, driveway, barrier, wall (such as a retaining wall used for landscaping), or other structure. In that case, the soil conditioner or surface material would be inserted, pressed, or otherwise placed in any suitable manner into the spaces between the material to be adhered.

Having now described preferred embodiments of the invention variations that do not depart from the spirit thereof will become apparent to others. The invention is thus not limited to the preferred embodiments but is instead set forth in the following claims and legal equivalents thereof. Unless stated otherwise in the claims, method steps may be performed in any order capable of providing a product or result according to the invention.

What is claimed is:

1. A soil conditioning product for mixing with a soil, the soil conditioning product comprising organic binder mixed with gypsum.

2. The soil conditioning product of claim 1 wherein the organic binder comprises dried and ground plantago.

3. The soil conditioning product of claim 2 wherein the organic binder comprises dried and ground plantago seed husk.

4. The soil conditioning product of claim 1 that comprises approximately equal parts by weight of organic binder and gypsum.

5. The soil conditioning product of claim 1 that comprises liquid gypsum.

6. The soil conditioning product of claim 4 that comprises liquid gypsum.

7. A soil conditioning product for mixing with a soil, the soil conditioning product comprising an organic binder and one or more of gypsum, vermiculite, and perlite.

8. The soil conditioning product of claim 1 that includes liquid gypsum and further comprises wax, wherein the liquid gypsum and wax are in a ratio of about 1 fluid cup of liquid gypsum per 100 gallons of wax.

9. The soil conditioning product of claim 1 that includes a liquid gypsum and wax in a ratio of between 1 fluid cup of liquid gypsum to between 80-120 gallons of wax.

10. The soil conditioning product of claim 1 that further comprises one or more of an oil, a gel, a polymeric binder, fibers, and a wax.

11. The soil conditioning product of claim 7, wherein the organic binder includes dried and ground plantago.

12. The soil conditioning product of claim 11, wherein the organic binder includes dried and ground plantago seed husk.

13. The soil conditioning product of claim 12, wherein the organic binder comprises 80% or more by weight dried and ground plantago seed husk.

14. The soil conditioning product of claim 6 that comprises between 20% to 80% by weight of organic binder.

15. The soil conditioning product of claim 6 that comprises between 40% to 60% by weight of organic binder.

16. The soil conditioning product of claim 1 that further comprises wax.

17. The soil conditioning product of claim 16 wherein the wax is soy wax.

18. The soil conditioning product of claim 16 wherein the wax is an emulsified wax.

19. The soil conditioning product of claim 1 that further comprises an oil.

20. The soil conditioning product of claim 19 wherein the oil is soy oil.

21. The soil conditioning product of claim 19 wherein the oil is paraffinic oil.

22. The soil conditioning product of claim 9 that further comprises a polymeric binder.

23. The soil conditioning product of claim 22 wherein the polymeric binder comprises amorphous olefin.

24. The soil conditioning product of claim 1 that further comprises wax and oil wherein the percentage by weight of wax to oil is between 10% and 90%.

25. The soil conditioning product of claim 1 that further comprises a gel.

26. The soil conditioning product of claim 25 wherein the gel comprises petroleum.

27. A surface material including the soil conditioning product of claim 1.

28. The surface material of claim 27, wherein the soil conditioning product is a mixture of gypsum and dried and ground organic binder.

29. The surface material of claim 27, wherein the soil conditioning comprises between about 5 to about 40 pounds of gypsum per ton of soil.

30. The surface material of claim 27, wherein the soil conditioning product includes a mixture of liquid gypsum and wax at a ratio of about 1 fluid cup of liquid gypsum per 100 gallons of wax, wherein the soil conditioning product includes between about 5 gallons and about 50 gallons of the liquid gypsum and wax mixture per ton of soil.

31. The surface material of claim 27 wherein the organic binder includes dried and ground plantago.

32. The surface material of claim 31 wherein the organic binder includes dried and ground plantago seed husk.

33. The surface material of claim 32 wherein the organic binder comprises 80% or more dried and ground plantago seed husk.

34. The surface material of claim 27 wherein the soil conditioning product comprises between 20% to 80% by weight of organic binder.

35. The surface material of claim 27 wherein the soil comprises one or more of the group consisting of sand, silt, crushed stone, clay and gravel.

36. The surface material of claim 35 wherein the crushed stone is decomposed granite.

37. The surface material of claim 35 wherein the soil conditioning product comprises a polymeric binder.

38. The surface material of claim 27 that comprises between 5 to 100 lbs. of soil conditioning product per ton of soil.

39. The surface material of claim 27 wherein the soil conditioning product further comprises one or more of an oil, a gel, a polymeric binder, fibers, and a wax.

40. The surface material of claim 27 that includes between 8 to 20 lbs. of soil conditioning product per ton of soil.
